(19) United States
(12) Patent Application Publication
(10) Pub. No.: US 2008/0198629 A1
(43) Pub. Date: Aug. 21, 2008

(54) Socket & cap of Christmas light strings

(76) Inventor: Han-Ming Lee, Hsin Chu City (TW)

Correspondence Address: Han-Ming Lee, P.O. Box 7-820, Taipei, omitted

(21) Appl. No.: 11/707,544

(22) Filed: Feb. 20, 2007

(51) Int. Cl. H01R 33/00

(52) U.S. Cl. 362/654

(57) ABSTRACT

The present invention is related to a socket & cap of Christmas light strings, comprising a socket, cap and two conductive pieces, wherein the bottom of the socket is provided with a central baffle plate, on the two sides of which are opposite bent L-shaped buckle slabs to achieve the effect of smooth embedding and locating of the two wings of the conducting pieces, from which S springs extend upward. The ends of the springs prop up the inner wall of the socket outward to perform the function of mutual jacking/conduction of the middle section of the two S springs, and the holes of the two light bases of the cap are provided with central guidances enabling the conductive bases of the light bulb to reach the central position of the two sides of the cap along the bending point so that the bases of the light bulb can be embedded between the two S springs for conduction, lighting and rapid operation. In particular, the burnt light bulb may be removed directly to keep the entire string of light bulbs illuminating.

### BACKGROUND OF THE INVENTION

Presently-sold Christmas light strings exported to Europe and USA are generally made by threading the bulb base filament through the holes below the cap and then expanding and bending the two conductive base filaments outward so that the light bulb is embedded into the socket through the cap contacting the two outer sides of the inner diameter to conduct electricity for the end pieces. However, for this conventional structure, as the two outer bent filaments are prone to tilt with the embedded cap, therefore leading to poor contact and conduction, they usually become loose and short-circuited when the power supply is not stable. And for this structure, if one of the light bulbs is burnt, the entire string of light bulbs is short-circuited and fails to illuminate. Hence, the presently-sold cap & socket structure actually require the improvements to be more ideal for use.

### SUMMARY OF THE INVENTION

The primary purpose of this invention is to provide a socket & cap of Christmas light strings, wherein the bottom of the socket is provided with a central baffle plate, on the two sides of which are opposite bending L-shaped fastening pieces to enable smooth embedding and positioning of the two wings of the conductive pieces.

The secondary purpose of this invention is to provide a socket & cap of Christmas light strings, wherein the S springs extend upward from conductive pieces. The ends of the spring prop up the inner wall of the socket to perform the function of mutual reaching and conduction of the middle section of the two S springs.

Another purpose of this invention is to provide a socket & cap of Christmas light strings, wherein the holes of the two light bases of the cap are provided with central guidances enabling the conductive bases of the light bulb to reach the central position of the two sides of the cap along the bending point.

One more purpose of this invention is to provide a socket & cap of Christmas light strings, wherein the conductive pieces perform the function of mutual reaching and conduction of the middle section so that the burnt light bulb can be removed directly to keep the light bulbs of the light strings illuminating.

### BRIEF DESCRIPTION OF THE DRAWINGS

FIG. 1 is the example of the best practice for this invention.

FIG. 2 is the decomposition diagram of the components in this invention.

FIG. 3 is the cross-sectional 3D view of the elements of this invention.

FIG. 4 is the schema of function of smooth embedding of the L-shaped fastening pieces of the two wings of this invention.

FIG. 5 is the schema of the guidances that enable the conductive bases of the light bulb to reach the central position of the two sides of the socket for positioning of this invention.

FIG. 6 is the schema of function of the light bulb of this invention embedded between two S springs for conduction.

### DETAILED DESCRIPTION OF THE PREFERRED EMBODIMENT

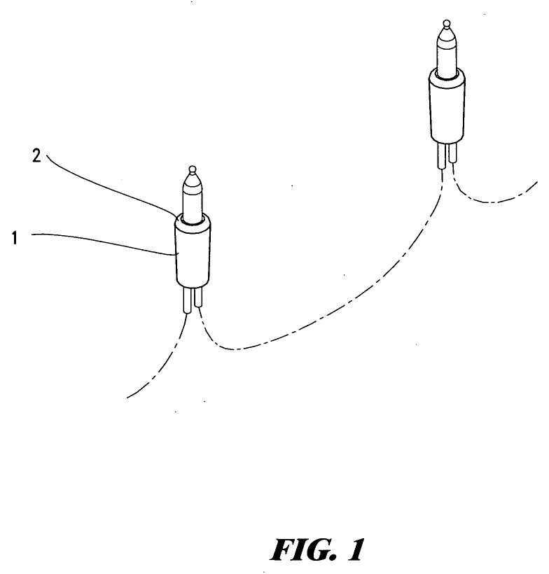

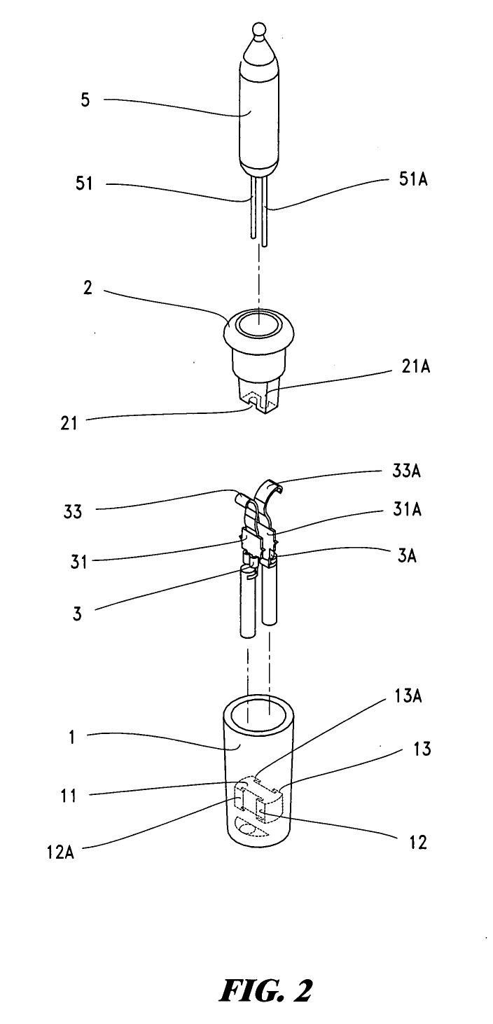

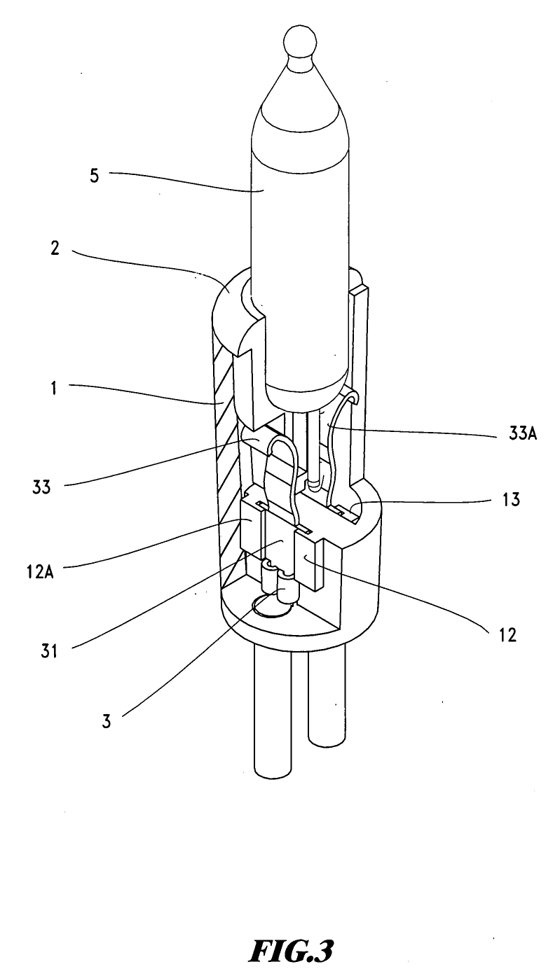

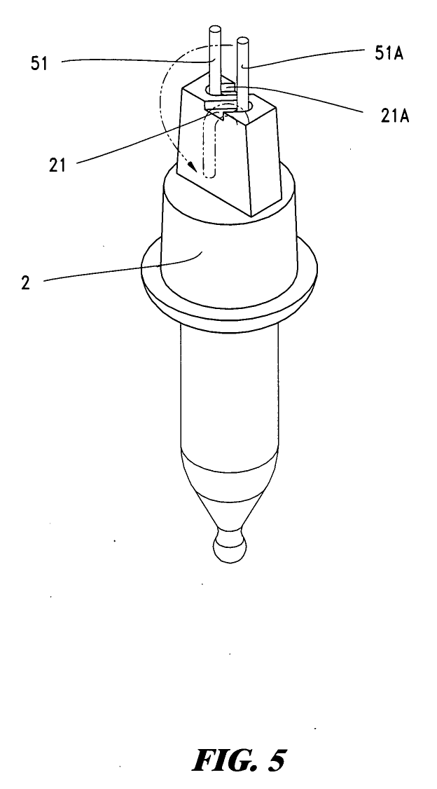

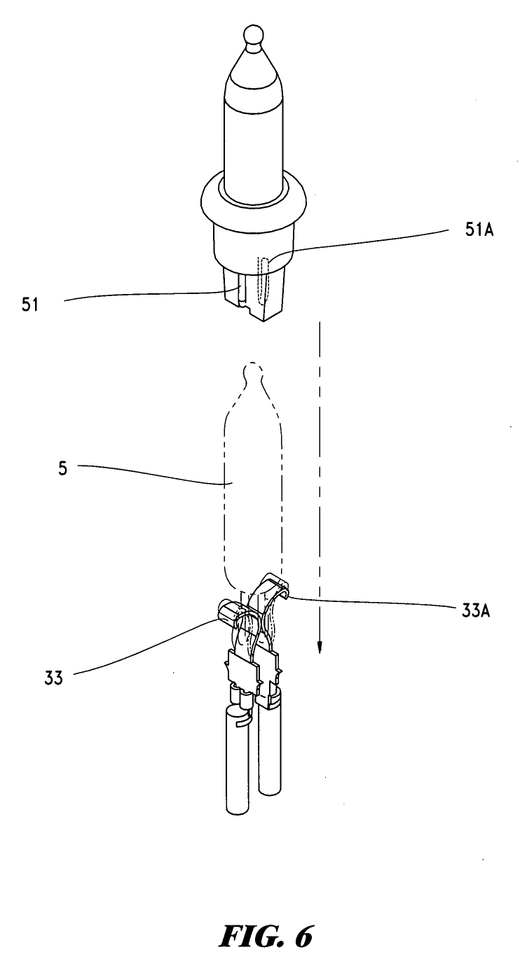

Referring to FIG. 1 through FIG. 6, this invention involves a socket & cap of Christmas light strings, comprising the socket 1, cap 2 and two conductive pieces 3 and 3A, wherein the socket 1 is the hollow round bottom provided with central baffle plate 11, on the two sides of which are opposite bent L-shaped fastening pieces 12, 12A, 13 and 13A; cap 2 is the hole of two light bases of conventional cap structure provided with central guidances 21 and 21A for the conductive bases 51 and 51A of light bulb 5 to reach the central position of the two sides of the cap along the bending point; S springs 33 and 33A extend upward from conductive pieces 3 and 3A for two locating wings, the ends of which bend outward to prop up the inner wall of the socket, which is the main structural characteristic for this invention.

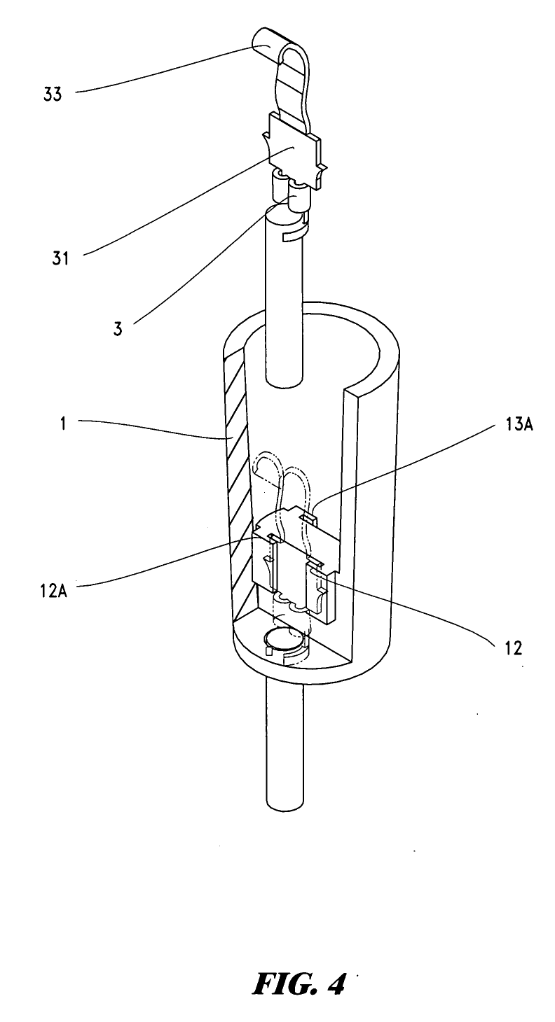

Embodiment of this invention. Referring to FIG. 4 through FIG. 6, the opposite L-shaped fastening pieces 12, 12A, 13 and 13A on the two sides of the central baffle plate 11 provide the two wings 31 and 31A of conductive pieces 3 and 3A with smooth embedding and locating function and two S springs 33 and 33A extend upward from the conductive pieces to achieve the effect of mutual reaching and conduction of the middle section while maintaining uninterrupted power supply for the light bulbs of the entire light string and the cap 2 enables the two inserted conductive bases 51 and 51A of the light bulb 5 to reach the central position of the two sides of the cap for positioning along the guidances 21, and 21A so that the cap enables the two S springs to be embedded for easy operation of conduction and illumination. However, for the above embodiment, the burnt bulb can be removed directly to keep the whole string of light illuminating.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

What is claimed is:

1. A socket & cap of Christmas light strings, comprising the socket, cap and two conductive pieces, wherein:
Said socket being a hollow round bottom provided with a central baffle plate, on the two sides of which are opposite bending L-shaped fastening pieces;
Said cap, being the hole of two light bases of conventional cap structure provided with central guidances for the conductive bases of the bulb to reach the central position of the two sides of the cap along the bending point;
Said conductive piece, from which an S spring extends upward for the two locating wings, the ends of which bend outward to prop up the inner wall of the socket;
With the above formation, the opposite bending L-shaped fastening pieces on the two sides of the central plate provide the function of smooth embedding and locating of the two wings of the conductive piece, from which extend the two S springs upward to achieve the effect of mutual reaching and conduction of the middle section to maintain the power supply for the entire string of light bulbs uninterrupted and the two conductive bases inserted in the cap may reach the central position of two sides of the cap along the bending point of the guidances so that the cap as a whole is embedded between the two S springs to achieve the effect of conduction, illumination and easy operation.
